(19) United States
(12) Patent Application Publication
(10) Pub. No.: US 2024/0157621 A1
(43) Pub. Date: May 16, 2024

(54) EXTRUSION RESIDUE SHEARS AND METHOD FOR SHEARING OFF AN EXTRUSION RESIDUE

(71) Applicant: SMS group GmbH, Duesseldorf (DE)

(72) Inventors: Christian STRICK, Erftstadt (DE); Valentin GALA LOSADA, Moenchengladbach (DE); Markus SCHAPRIAN, Duesseldorf (DE)

(73) Assignee: SMS group GmbH, Duesseldorf (DE)

(21) Appl. No.: 18/388,916

(22) Filed: Nov. 13, 2023

(30) Foreign Application Priority Data
Nov. 14, 2022 (DE) 10 2022 129 994.5
Feb. 27, 2023 (DE) 10 2023 104 739.6

(51) Int. Cl. B29C 48/27; B26D 1/08

(52) U.S. Cl. CPC B29C 48/272; B26D 1/08

(57) ABSTRACT

A precise shearing process can be made possible, with a cost-advantageous embodiment of extrusion residue shears, if the shearing forces and the shearing movement are applied or carried out in as compact and targeted a manner as possible. This can be implemented, in the case of a suitable embodiment of the corresponding extrusion residue shears or of the corresponding method, in each instance, by a suitable embodiment of the drive train that belongs to the shearing movement, by pulling of the related shear blade, by a shearing drive that is separate from positioning and/or by suitable regulation.

### CROSS REFERENCE TO RELATED APPLICATIONS

Applicant claims priority under 35 U.S.C. § 119 of German Application No. 10 2022 129 994.5 filed on Nov. 14, 2022 and German Application No. 10 2023 104 739.6 filed on Feb. 27, 2023, the disclosures of which are incorporated by reference.

### BACKGROUND OF THE INVENTION

### 1. Field of the Invention

The invention relates to extrusion residue shears for extrusion presses, having a shearing blade and a shearing drive, which moves the shearing blade correspondingly with reference to a frame of the extrusion residue shears during a shearing movement that runs along a shear-off direction. Likewise, the invention relates to a method for shearing off an extrusion residue in the case of an extrusion press, by means of a shearing blade.

Such extrusion residue shears are known, for example, from U.S. Pat. No. 8,490,453 B2, from US 2014/0260488 A1, from US 2014/0250967 A1, from U.S. Pat. No. 4,593,552 and from WO 2013/108222 A1, wherein a hydraulic cylinder/piston arrangement, in each instance, acts directly, in other words, in particular, without a gear mechanism, as a shearing drive, on a shearing blade carrier and on a shearing blade carried by the shearing blade carrier, so as to carry out a corresponding shearing process. This shearing process serves for shearing off an extrusion residue that remains in front of a die during the extrusion of metal in an extrusion press, so that a new extrusion process can be carried out.

In this regard, a distinction must be made between the actual shearing process, during which the shearing blade is moved past the die very closely, so as to shear off possible extrusion residues, and a positioning movement, with which the shearing blade is brought from a waiting position into a shearing start position, in which the shearing blade is then already so close to the die that any extrusion residues that are situated on the die can be captured by the shearing process. In the documents mentioned above, in this regard the cylinder/piston arrangement that serves as the shearing drive also participates in the positioning movement, with a driving effect, wherein if applicable, additional cylinder/piston arrangements are supplementally used so as to displace the shearing blade from the waiting position to the shearing start position in a suitable manner.

EP 3 389 885 B1 also displaces the shearing blade from a waiting position to a shearing start position, both by using the shearing drive, which is implemented, also in this document, by means of a hydraulic cylinder/piston arrangement, and by using a specially configured positioning drive, which is, however, driven by an electric motor and comprises a worm gear.

U.S. Pat. No. 9,114,447 B2, on the other hand, discloses an electric motor drive as the shearing drive, wherein a belt drive is arranged between the shearing drive and the shearing blade carrier, in other words also the shearing blade, which belt drive converts a rotational movement of the electric motor shearing drive to a linear movement.

### SUMMARY OF THE INVENTION

It is the task of the present invention to make available extrusion residue shears as well as a method for shearing off an extrusion residue, which method makes available a precise shearing process with a cost-advantageous embodiment, in particular for smaller and cost-advantageous or electrically driven extrusion presses.

The task is accomplished by means of extrusion residue shears and a method for shearing off an extrusion residue, having the characteristics of the invention. Further advantageous embodiments, if applicable also independent of these, can be found below.

In this regard, the invention proceeds from the basic idea that a precise shearing process can be made possible, with a cost-advantageous embodiment of extrusion residue shears, if the shearing forces and the shearing movement are applied or carried out in as compact and targeted a manner as possible. This can be implemented, in the case of a suitable embodiment of the corresponding extrusion residue shears or of the corresponding method, by means of a suitable embodiment, in each instance, of the drive train that belongs to the shearing movement, by means of pulling of the related shearing blade, by means of a shearing drive separate from the positioning and/or by means of suitable regulation.

Thus, for implementing the aforementioned basic idea or for a precise shearing process with a cost-advantageous embodiment, extrusion residue shears for extrusion presses, having a shearing blade and a shearing drive, which moves the shearing blade accordingly, with reference to a frame of the extrusion residue shears, during a shearing movement that runs along a shear-off movement direction, can be characterized in that the shearing drive is connected to the shearing blade by means of a geared connection that acts with push.

In this regard, in the present connection the term “drive” refers to a power machine that performs mechanical work, in that it converts a form of energy, for example thermal, chemical, hydraulic, pneumatic or electrical energy to movement energy. Depending on the concrete embodiment, this movement can then be used directly or by way of a gear mechanism.

Accordingly, the term “shearing drive” refers to a drive that moves the shearing blade accordingly, with reference to a frame of the extrusion residue shears, during a shearing movement that runs along a shear-off movement direction. In this regard, the shearing movement is precisely the movement that the shearing blade performs in order to carry out the actual shearing process, by means of which an extrusion residue, which remains in extrusion presses at specific locations, in particular, for example, on the press side of an extrusion press, is cut off.

In this connection, it should be explained, in particular, that a shearing blade generally also performs other movements, such as, for example, a return stroke or positioning movements, since the shearing blade generally cannot remain in its position after cutting off the extrusion residue, but rather must or should at least be brought back into a shearing start position.

In this regard, the shearing movement as such generally ranges from a shearing start position to a shearing end position, while further movements, such as, for example, a return stroke, then can bring the shearing blade back into its shearing start position. In this regard, it is not only conceivable but actually the rule that the shearing blade is positioned in its shearing start position in such a manner that it hinders, for example, the actual extrusion process that the extrusion press performs or is supposed to perform, or other movement sequences that are supposed to be carried out in the extrusion press or during the extrusion process, so that—as a rule—the shearing blade, if it is not supposed to cut off and be effective at a specific time, is brought into a waiting position that is selected in such a manner that the shearing blade as well as further modules of the extrusion residue shears does/do not hinder the extrusion process or other sequences that are supposed to be performed by the extrusion press.

In this regard, it is understood that the waiting position does not necessarily have to be a single fixed waiting position, but rather that it is also possible that the shearing blade runs in a waiting loop or is situated in different waiting positions, as long as it is not brought back into its shearing start position for the shear-off movement.

For classification, it should be explained that extrusion presses in the present connection are presses that can serve for primary forming or forming methods. For example, using an extrusion press, in particular metallic wires, rods, pipes and/or other prismatic profiles can be produced. Such extrusion presses can, in particular, however, also work with powder-type materials, for example with metallic, ceramic powders or powders containing hard substances, with graphite powders or mixtures thereof, wherein corresponding granulates can also be equated with these, and, if applicable, the powders or granulates can be sufficiently compacted and pressed or suitably sheathed in advance, so as to then be able to load these into the recipient of an extrusion press. It is conceivable that plastic materials can also be processed, wherein the method is then frequently referred to as extrusion.

In the present connection, extrusion presses preferably comprise an extrusion punch, so that they can be filled at least discontinuously, in that the materials to be pressed are filled into a corresponding recipient, and subsequently the extrusion punch penetrates into the recipient so as to then press the material through a die and out of the recipient.

The present extrusion presses are advantageously used for the processing of metallic materials and are then referred to, if applicable, as metal extrusion presses. Preferably, profiles composed of stainless steel or aluminum undergo primary forming or forming using the present metal extrusion presses, wherein it is understood that the use of the extrusion press of the present invention is not restricted to this, but rather can also be used for other products.

Because of the discontinuous filling, an extrusion residue often occurs in extrusion presses, and this is specifically not supposed to remain in the extrusion press. The present extrusion residue shears, which serve to shear off this extrusion residue, are then intended precisely for such cases.

By its nature, the shearing blade is subject to relatively great stress, since it is supposed to shear off the residue and comes into contact with the extrusion residue, in each instance. Accordingly, the shearing blade is frequently a wear part and is replaceably attached to a shearing blade carrier, which is driven by the shearing drive or the related drive train, and imposes at least the shear-off movement, but preferably the entire movement of the shearing blade, on the shearing blade.

In this regard, the shearing drive is intended, at first, merely for the actual shearing process and is merely supposed to impose the actual shearing movement from the shearing start position to the shearing end position on the shearing blade, or, accordingly, on the shearing blade carrier.

On the other hand, it is understood that the shearing drive, depending on the concrete embodiment, can also perform a reverse movement or return stroke, or, alternatively, if the shearing drive is configured as a rotational drive, a further movement, in order to get back into a starting position for a subsequent shearing process. Depending on the concrete implementation, this further movement of the shearing drive can also be imposed on the shearing blade or the shearing blade carrier or, alternatively, for example by means of gear mechanisms or by means of further drives, can lead to other movements of the shearing blade or of the shearing blade carrier. In the end result, it is only important that the shearing drive, after performing a shearing movement, is enabled to once again allow a shearing movement of the shearing blade at the given point in time.

As has already been explained above, the shearing drive can be part of a drive train for the shearing blade or for the shearing blade carrier, which drive train also comprises a geared connection, so that the shearing drive is connected to the shearing blade by means of this geared connection. Preferably, this geared connection can then, as has already been explained, be configured to also act with push, and this, in particular, allows the most compact and targeted possible application of the shearing forces or the shearing movement in the case of a suitable embodiment of the extrusion residue shears, so that a precise shearing process is made possible, with a cost-advantageous embodiment of the extrusion residue shears. This results, in particular, in a clear distinction as compared with the belt drive of U.S. Pat. No. 9,114,447 B2, which serves, in the arrangement according to this document, for converting the rotational movement of the shearing drive to a linear movement of the shearing blade, and which, due to the belt, can be effective only with pull, in other words specifically not with push. Although it is true that such a belt drive can have a relatively cost-advantageous structure, this does, however, lead to great inaccuracies in the precision of the transmitted movement. This can be countered, in the case of a suitable selection of a corresponding geared connection, by means of a gear mechanism that also acts with push, which generally allows a significantly more precise transmission of movement.

In this regard, it is understood that the gear mechanism that also acts with push or the geared connection that also acts with push does not necessarily have to interact with the shearing blade with push, but this can be the case. In particular, it is also conceivable that a gear mechanism that acts with push or a geared connection that acts with push ultimately leads to a pulling movement sequence. This is exactly the opposite of the embodiment according to U.S. Pat. No. 9,114,447 B2, in which the geared connection that acts solely with pull drives the shearing blade with push, in that a pull engagement occurs on the shearing blade carrier, in each instance, for the shear-off movement and for the return stroke.

Ultimately, the geared connection that acts with push can be any such gear mechanism or can be configured as such a gear mechanism, as long as in this way, a movement can be transmitted by push and adapted to the desired conditions, for example by means of a translation. In particular, suitable lever arrangements can also be included. In practice, however, toothed gear mechanisms have proven to be particularly advantageous, in particular because in this way, rotational movements using push, as they are frequently found in drives, and accordingly also in a selected shearing drive, can be precisely and cost-advantageously converted to linear movements, as these are generally performed by the shearing blade.

The utilization of rotating shearing drives has the advantage that particularly cost-advantageous drives, such as, in particular, rotational electric motor drives can be used.

Among the toothed gear mechanisms, screw gear mechanisms, in particular, allow a precise and low-friction movement sequence, so that such screw gear mechanisms, in particular, can be used as the geared connection acting with push, within the drive train of the shearing drive to the shearing blade. Also, high translation ratios can be achieved by means of screw gear mechanisms, in a structurally simple and relatively cost-advantageous manner, so that the relatively great forces that are required for shearing off can be applied even by means of relatively low-power and thereby cost-advantageous and small shearing drives.

In particular, rolling screw threads, such as, for example, ball screws or roller screws, can be used as screw gear mechanisms, which allow a particularly precise and low-friction movement sequence, and this accordingly brings about good translation performance of the related gear mechanism. Depending on the concrete implementation, however, other toothed gear mechanisms or other screw gear mechanisms, such as, for example, screw gear mechanisms with conventional gear wheels and/or nuts, which interact with a thread or a screw, can be used, if this appears to be advantageous or is possible for reasons of the friction conditions or for some other reasons.

The geared connection also working with push can advantageously be a mechanical geared connection, since such a mechanical geared connection can be configured in a cost-advantageous and precise manner. In this connection, it should be mentioned that the term “precise” is coordinate, in each instance, with the precision desired or selected for the shear-off process. On the other hand, it is understood that as an alternative to mechanical geared connections, in special embodiments other types or gear mechanisms, which act with push, can also be used, if applicable.

Preferably the mechanical geared connection, which also works with push, is a shape-fit geared connection, so that in this way, the risk of excessive friction losses or of slip can be reduced to a minimum. The latter can be done, in particular, with a justifiable cost expenditure, because, for example in the case of friction-fit connections, it generally proves to be relatively time-consuming and expensive to guarantee a sufficiently great friction fit in all operating states.

In particular, the mechanical and shape-fit geared connection can comprise a nut/spindle drive for changing a rotational movement of the shearing drive into the shearing movement, wherein such a gear mechanism, depending on the concrete embodiment, can be configured, in particular, as a rolling gear mechanism, if this were to appear to be practical.

Independent of the precise configuration of the geared connection that also works with push, it appears to be advantageous if in the case of extrusion residue shears for extrusion presses, having a shearing blade and a shearing blade drive that moves the shearing blade accordingly with reference to a frame of the extrusion residue shears, during a shearing movement that runs along a shear-off movement direction, or in the case of a method for shearing off an extrusion residue in an extrusion press, by means of a shearing blade, to convert a rotational movement or rotating movement of the shearing drive to the shearing movement, in particular because the latter generally takes place in a linear manner or only in one dimension. In particular, in the case of such an implementation, as well, the geared connection that also works with push can be configured in accordance with the detailed embodiment of such geared connections as explained above.

Independent of the other combinations of characteristics mentioned in the present case, a precise shearing process can be made possible, with a cost-advantageous embodiment of extrusion residue shears, if the extrusion residue shears for extrusion presses, having a shearing blade and a shearing drive that moves the shearing blade accordingly, with reference to a frame of the extrusion residue shears, during a shearing movement that runs along a shear-off movement direction, is characterized in that the shearing drive comprises a linear actuator that performs the shearing movement. Ultimately, in this regard all linear actuators having a performance spectrum or speed spectrum with an appropriate introduction of energy and having an appropriate reaction time for the shearing drive can be sufficient, and can also be used in this regard. In particular, electromechanical linear drives, such as linear motors having an electrodynamic principle of effect or linear actors having piezo-electric, electrostatic, electromagnetic, magnetostrictive or thermo-electric or similar principles of effect can be used accordingly.

Accordingly, it is particularly advantageous if the linear actuator is configured as an electric motor.

Cumulatively or alternatively, it is advantageous if the shearing drive comprises an electric motor or is configured as an electric motor, and this accordingly allows a cost-advantageous and precise embodiment of the shearing process with a cost-advantageous embodiment of the extrusion residue shears. In particular, the advantages of an electric motor drive, i.e. the low effort for control as well as the low degree of contamination, can then be utilized accordingly.

An electrical energy supply of the shearing drive of extrusion residue shears for extrusion presses, having a shearing blade and a shearing drive that moves the shearing blade accordingly with reference to a frame of the extrusion residue shears, during a shearing movement that runs along a shear-off movement direction, or in the case of a method for shearing off an extrusion residue in an extrusion press, by means of a shearing blade, has the advantage, even independent of the combinations of characteristics explained above, that a shearing drive that takes place independent of a central drive station or energy supply can be made possible. In particular, in the case of a suitable embodiment, it is possible to do without hydraulic lines for the shearing drive, and this is advantageous with regard to costs and safety.

Depending on the concrete implementation of the extrusion residue shears, it can, if applicable, already be sufficient to replace a hydraulic or pneumatic drive of the extrusion residue shears with a linear actuator, so as to be able to utilize the advantages described above directly.

Ultimately, the shearing blade or the shearing blade carrier cannot have a shearing effect while completely free-standing, for the shearing movement or for other positioning movements or return strokes with the shearing drive, because the shearing forces must be absorbed in some way. The frame, which positions the extrusion residue shears in a suitable manner in a spatial relation to the extrusion press, serves for this purpose.

In general, the frame will comprise modules that are attached fixed in place with reference to the extrusion press or actually fastened to suitable modules of the extrusion press. Furthermore, the frame can, however, also comprise movable modules, which can serve, for example, for positioning of the shearing blade, of the shearing blade carrier and/or of the shearing drive, for example so as to move these modules into a shearing position, in particular into a shearing start position, or into a waiting position. Depending on the concrete definition, for example, all the modules of the extrusion residue shears that serve for force fit between the shearing drive and the shearing blade, aside from the drive train of the shearing blade, can be referred to as modules of the frame. This definition would then also include possible positioning drives and the like as modules of the frame. In another definition, however, the frame itself can be restricted to modules that are rigid in themselves, which do belong to the extrusion residue shears, but are not found in the drive train between the shearing drive and the shearing blade or do not move with it. However, both types of definitions clearly distinguish the drive train of the shearing drive from the remaining modules of the extrusion residue shears, while even more detailed restrictions with regard to the frame, for example that it consists exclusively of modules that cannot move relative to the extrusion press, do not appear to be compulsory, but nevertheless lead to a satisfactory distinction of the frame relative to the remaining essential modules of the extrusion residue shears.

Independent of the other combinations of characteristics presented in the present case, extrusion residue shears for extrusion presses, having a shearing blade and a shearing drive, which moves the shearing blade accordingly with reference to a frame of the extrusion residue shears, during a shearing movement that runs along a shear-off movement direction, can be characterized, cumulatively or alternatively, in that the shearing drive can be driven both with force regulation and with speed regulation, so as to make available a precise shearing process with a cost-advantageous embodiment, in particular for smaller and cost-advantageous or electrically driven extrusion presses. Such an embodiment makes it possible, for example, to carry out a shearing movement with force regulation and a positioning movement with speed regulation, so that the shearing drive can be operated, during positioning movements or similar movements, at a defined speed and thereby as quickly as possible, as long as the movement still takes place with a sufficient degree of control. The shearing movement, on the other hand, if it is force-regulated, can react, in particular, to the stresses that occur during shearing off, in a simple and operationally safe manner, and this accordingly allows a precise shearing process with a cost-advantageous embodiment. It is understood that if applicable, more complex movement sequences can also be regulated individually, accordingly, as a function of the corresponding type of movement or as a function of the set of problems to be expected during the corresponding movement. In particular, it is also conceivable, if applicable, that in a certain manner, overlapping regulation, for example a minimum speed during the shearing movement, or the like, can be selected, so as to optimize the movement sequence, in particular during shearing off.

Accordingly, it can be advantageous, cumulatively or alternatively, independent of the other combinations of characteristics mentioned in the present case, if a method for shearing off an extrusion residue in an extrusion press, by means of a shearing blade, is characterized in that the shearing blade is driven both with force regulation and with speed regulation, so as to make available a precise shearing process with a cost-advantageous embodiment, in particular for smaller and cost-advantageous or electrically driven extrusion presses.

By means of the combination of a force regulation and a speed regulation, the most compact and targeted application possible of the shearing forces or of the shearing movement can be made possible.

In particular, the shearing drive can be force-regulated for the shearing movement or during the shearing movement, and this allows precise process management and, in particular, precise application of the shearing forces during shearing off. In this regard, it is understood that during specific time points of the process during shearing off, in particular, for example, in the vicinity of the shearing start position or just before reaching the shearing end position, further regulation parameters, such as, for example, a speed regulation or also a position regulation can supplementally be used, without deviating from the fundamental principle of force regulation of the shearing drive during or for the shearing movement.

For the remainder, it can be advantageous to operate the shearing drive with speed regulation at specific points in time or during specific movements, and to use speed regulation of the shearing drive for the remainder. This can be advantageous, for example, in the case of a return stroke or during positioning movements. This holds true, in particular, in interplay with a force-regulated shearing drive during or for the shearing movement, and allows the most precise method sequence possible with a suitable embodiment of the extrusion residue shears or suitable method management.

In order to simplify regulation, a force sensor and/or a torque sensor can be provided in the flow of force between the shearing drive and the shearing blade. Cumulatively or alternatively to this, the shearing drive can comprise a force sensor and/or a torque sensor. In this way, measurement of the applied forces or moments is made possible, and this then makes precise or more precise control of the shearing drive and thereby, accordingly, more precise method management possible.

The force regulation or speed regulation explained above proves to be advantageous, in particular, in connection with a shearing drive configured with an electric motor, as it has already been explained above. Accordingly, it is also advantageous if, independent of this, shearing off or the shearing movement takes place by means of an electric motor. In particular, in this manner a precise shearing process can be made available, with a cost-advantageous embodiment, in particular for smaller and cost-advantageous or electrically driven extrusion presses.

In order to make available a precise shearing process with a cost-advantageous embodiment, in particular for smaller and cost-advantageous or electrically driven extrusion presses, extrusion residue shears for extrusion presses, having a shearing blade and a shearing drive that correspondingly moves the shearing blade with regard to a frame of the extrusion residue shears during a shearing movement that runs along a shear-off movement direction, can be characterized, independent of the other combinations of characteristics explained in the present case, cumulatively or alternatively to them, in that the shearing drive is switched in series with a specially configured positioning drive for carrying out a positioning movement of the shearing blade, this movement having a directional component in common with the shearing movement, from a waiting position to a shearing start position and/or from a shearing end position to the waiting position.

Cumulatively or alternatively to this, a method for shearing off an extrusion residue in an extrusion press, by means of a shearing blade, can be characterized, independent of the other combinations of characteristics explained in the present case, in that the shearing blade is first brought from a waiting position into a shearing start position, then, for the shearing process, is moved, by means of a shearing movement, all the way to a shearing end position, and subsequently brought back into the waiting position, wherein the shearing movement is driven by means of a shearing drive, and at least one of the other movements, having a directional component in common with the shearing movement, is driven by means of a positioning drive that is separate from the shearing drive.

Although it appears nonsensical, at first, to provide a positioning drive that has a directional component in common with the shearing movement and thereby ultimately causes a movement having a directional component that corresponds to the movement direction brought about by the shearing drive, this embodiment appears to be advantageous, because a fast positioning movement can be made available in a structurally simple manner, with little force and great force for the shearing movement, in that the corresponding drives, in other words the positioning drive and the shearing drive, or the related drive trains, can be configured in a specialized manner for the positioning, on the one hand, and the shear-off, on the other hand. Thus, for example, the shearing drive or its drive train can be designed for the purpose of applying great shearing forces. Ultimately, however, it would be unnecessary to use a drive or drive train specialized for the application of great force also for positioning movements, for which no great forces are generally needed. On the other hand, for example, a positioning drive or its drive train can be designed for making the greatest possible speeds available quickly and in an operationally reliable manner, and this generally does not require the application of great forces or does not make it possible if a cost-advantageous construction is used. By means of the specialization of the two drives or drive trains, cost-advantageous implementation can unexpectedly be achieved, because the corresponding drives then do not have to be used, or only have to be used very little, for movement sequences for which they are not specialized. Accordingly, this results in a precise shearing process with a cost-advantageous embodiment, wherein this, in particular, holds true in interplay with an electric motor shearing drive.

In a preferred embodiment, in particular, the positioning drive can also be configured with an electric motor, and this accordingly allows relatively cost-advantageous and compact implementation of the shear-off method or of the extrusion residue shears. Depending on the concrete implementation, such an electric motor positioning drive or electrical energy supply of the positioning drive makes it possible, independent of the other combinations of characteristics explained in the present case, with a suitable embodiment, to do without hydraulic lines for the positioning drive, with the corresponding possibility of cost reduction and/or risk reduction or of a positioning drive that is independent of a central drive station.

Thus, it is known, for example from U.S. Pat. No. 9,114,447 B2, to carry out both the positioning movement and the shearing movement, using a single drive, wherein the path distance of the drive must then be structured in such a manner that it reaches from the waiting position all the way to the shearing start position and to the shearing end position. Precisely this then requires that a correspondingly highly dimensioned shearing drive, which must apply the suitable forces so as to carry out the shearing movement, must also be used over a very long path distance for the positioning movement. Other solutions are shown by US 2014/0260488 A1, US 2014/0250967 A1, U.S. Pat. No. 4,593,552, WO 2013/108222 A1, and EP 3 389 885 B1, in which a separate positioning drive is provided, in each instance, which does, however, bring about a positioning movement oriented perpendicular to the shearing movement. The latter means that although the positioning drive is configured separately from the shearing drive, the shearing drive does, however, still have to take on a large part of the positioning movement, since it is generally not possible, by means of a positioning drive structured in this way, and, in particular, in the case of this state of the art, to reach the shearing start position merely by way of the positioning drive. This looks different, in the case of a suitable embodiment for the remainder, if the movement that the positioning drive applies has a directional component in common with the shearing movement.

Accordingly, it is advantageous, in particular, if the shearing movement and the positioning movement make a constant transition into one another. This makes it possible, on the one hand, to achieve a particularly quiet movement sequence. On the other hand, in this way the distribution of the components of the movement that are caused by the positioning drive and those that are caused by the shearing drive can be optimized accordingly, and this, in particular, opens up cost advantages. Thus, for example, a linear actuator, which is supposed to be used only for the shearing movement and applies the greatest possible forces, can be selected to be correspondingly small and short. The same also holds true for a possible geared connection that is supposed to convert a rotational movement of the shearing drive to a linear movement. This can then also be selected to be as small and short as possible.

In particular, it is advantageous if the shearing movement and the positioning movement make a transition into one another with a constant change in direction or even without any change in direction, and this accordingly allows a correspondingly quiet movement sequence.

Although it was explained above that it can be advantageous if the linear actuator is used only for the shearing movement, embodiments are conceivable in which the linear actuator also brings about a position movement. This can apply, for example, if the costs for a correspondingly long linear actuator lie within relatively small limits. On the other hand, it is conceivable to structure a linear actuator in a differentiated manner, by way of its linear movement, so that it runs faster in the region of a positioning movement, at lower forces, and, if applicable, slightly slower in the region of the shearing movement, with great forces. In these cases, too, it can be advantageous if the linear actuator also performs a positioning movement. This also holds true for the case of geared connections, in which a gear mechanism is used so as to convert a rotational movement, for example of an electric motor, to a linear movement. Here, too, it will generally be advantageous to use the corresponding gear mechanism only for the shearing movement and, if applicable, for the related return stroke, wherein here, too, it is a question of costs and the concrete time sequences if the gear mechanism and therefore the shearing drive is/are also used or is/are supposed to be used for a positioning movement.

Frequently it will nevertheless prove to be advantageous if a positioning drive is supplementally provided, as this was already explained above, in particular. On the other hand, it is conceivable, in certain constellations, to do entirely without such a positioning drive and the advantages connected with it, in particular if the concrete time sequences in the process management during the entire extrusion process allow this or if the costs for a correspondingly designed linear actuator or for a correspondingly designed gear mechanism allow this.

Accordingly, it can be advantageous that in specific embodiments of the extrusion residue shears or in specific embodiments of the shear-off process, the shearing drive is used both for the drive of the shearing movement and also for the drive of the positioning movement. This makes a cost-advantageous structure possible, since no further drives for the extrusion residue shears are necessarily required. It is understood that on the other hand, in specific embodiments, as they were explained above, in particular, it is specifically possible to do without such double use of the shearing drive or to do without it in part, if this appears to be advantageous.

In this regard it can be advantageous, as has already been indicated above, if the shearing drive, in particular, if applicable, the linear actuator, can or does also perform a positioning movement of the shearing blade from a waiting position to a shearing start position and/or from a shearing end position to the waiting position. If a separate positioning drive is provided, the shearing drive can, in the case of such an embodiment, act supplementally to the positioning drive, if applicable. On the other hand, it is also conceivable that the shearing drive, as the sole drive, brings about both the shearing movement and the positioning movement. Depending on the concrete embodiment of the shearing drive, the corresponding movement can be moderated by means of a suitable embodiment of the drive train between the shearing drive and the shearing blade.

A precise shearing process with a cost-advantageous embodiment can be made available, independent of the other combinations of characteristics mentioned above, cumulatively or alternatively to them, by means of extrusion residue shears for extrusion presses, having a shearing blade and a shearing drive that moves the shearing blade accordingly with reference to a frame of the extrusion residue shears, during a shearing movement that runs along a shear-off movement direction, if these are characterized in that the shearing drive drives the shearing blade, for the shearing movement, along a shearing blade carrier that extends, proceeding from the shearing blade, in the shear-off movement direction, or together with a shearing blade carrier that extends, proceeding from the shearing blade, in the shear-off movement direction. In particular, in deviation from U.S. Pat. No. 9,114,447 B2, but also in distinction from the remaining prior art, this has the result that the shearing blade carrier does not extend, as is known from the prior art, counter to the shear-off movement direction, proceeding from the shearing blade, but rather in the shear-off movement direction. This makes the aforementioned compact structure possible, by means of which the shearing forces and the shearing movement can be applied or carried out in as compact and targeted manner as possible. This in turn results in as precise a shearing process as possible, with a cost-advantageous embodiment. In particular, it is then conceivable that the shearing blade is drawn against the extrusion residue in order to shear off the extrusion residue.

Accordingly, a precise shearing process with a cost-advantageous embodiment can be guaranteed by means of a method for shearing off an extrusion residue in an extrusion press, by means of a shearing blade, which method is characterized in that the shearing blade is drawn against the extrusion residue in order to cut off the extrusion residue, independent of the other combination [sic, singular] of characteristics mentioned above, in the present case, cumulatively or alternatively to them.

It is also understood that if applicable, smaller components of the shearing blade carrier can also be provided counter to the shear-off movement direction, proceeding from the shearing blade, as long as the major portion of the shearing blade carrier is arranged proceeding from the shearing blade, in the shear-off movement direction. Specifically such an embodiment can allow a drawing movement sequence.

Accordingly, it can be advantageous if drawing of the shearing blade against the extrusion residue takes place from a side of the extrusion residue that faces away from the shearing blade. This specifically allows very precise application of the shearing forces with minimal structural effort.

While U.S. Pat. No. 9,114,447 B2 utilizes a geared connection that merely acts with pull so as to drive a shearing blade having a shearing blade carrier that extends counter to the shear-off movement direction, with push, the embodiment of the shearing blade carrier having an expanse in the shear-off movement direction makes it possible to draw the shearing blade for the shearing movement. Precisely in the case of such an embodiment, it can be advantageous to use a gear mechanism element that only works with pull, so as to effectively connect the shearing drive to the shearing blade, because such gear mechanism elements, which act with pull, are relatively cost-advantageous, and the structural effort, if these gear mechanism elements that only act with pull are also supposed to perform a drawing movement, is relatively slight. Accordingly, it is advantageous if the shearing drive for the shearing blade, which is carried by the shearing blade carrier that extends in the shear-off movement direction, is connected to the shearing blade by means of a geared connection, which comprises a gear mechanism element that acts only with pull, such as, for example, a cable, a pull belt or a pull chain. The latter can be implemented in a structurally simple manner, as has already been indicated, and is relatively cost-advantageous.

It is understood that the characteristics of the solutions described above or in the claims can also be combined, if applicable, so as to be able to implement the advantages cumulatively, accordingly.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a schematic side view of the region of an extrusion press around the die crossbeam, with first extrusion residue shears in a waiting position;

FIG. 2 shows a detail of a front view of the extrusion residue shears according to FIG. 1;

FIG. 3 shows a schematic side view of the region of an extrusion press around the die crossbeam, with second extrusion residue shears in a waiting position;

FIG. 4 shows a detail of a front view of the extrusion residue shears according to FIG. 3;

FIG. 5 shows a schematic side view of the region of an extrusion press around the die crossbeam, with third extrusion residue shears in a waiting position;

FIG. 6 shows a front view of the extrusion residue shears according to FIG. 5 in a shearing start position;

FIG. 7 shows a front view of the extrusion residue shears according to FIGS. 5 and 6 in a shearing end position;

FIG. 8 shows a front view of fourth extrusion residue shears in a waiting position;

FIG. 9 shows a front view of fifth extrusion residue shears in a waiting position; and

FIG. 10 shows a front view of sixth extrusion residue shears in a shearing start position.

### DETAILED DESCRIPTION OF PREFERRED EMBODIMENTS

The extrusion residue shears 10, explained below using the exemplary embodiments and the drawings, serve for shearing off an extrusion residue of extrusion presses 11.

Such extrusion presses 11 generally comprise a die yoke 12, which can interact with a counter-yoke, which is not shown in the figures in the present case, but is sufficiently known, by way of tension rods 13, so that pressing forces can be absorbed by means of this arrangement.

For extrusion, a material to be pressed, such as, for example, a metallic block, is loaded into a recipient 14, which has a receiving space 15 for holding the material to be pressed, and pressed through a die 17 by means of a punch 16.

The pressing forces of the punch 16 are absorbed, in this regard, by the counter-crossbeam, not shown, and balanced out by way of the tension rod 13 and the die yoke 12, with the corresponding counter-forces.

The exemplary embodiments shown in the drawings are direct presses, while in the case of indirect presses, the punch is also supported on the die yoke, wherein then the punch carries the die 17 as the die carrier. In the case of indirect presses, the recipient 14 is then displaced, together with a counter-plate that closes the receiving space 15 on the side facing away from the die, in the direction of the punch and the die, so as to apply the pressing forces.

In the case of direct presses, as they are shown in the drawing, the die 17 is generally positioned on the die yoke 12 by way of a die carrier 18, wherein—if applicable—the positioning can also take place without a die carrier 18, directly on the die yoke 12.

It is understood that—depending on the concrete embodiment of the extrusion press 11—mixed forms between a direct press and an indirect press can also make use of corresponding extrusion residue shears 10, so as to be able to remove an extrusion residue from specific locations of the extrusion press 11.

Because the recipient 14 generally has to be or should be moved to charge it with material to be pressed or also for other purposes, for example during extrusion in the case of an indirect press, it has a recipient guide 19, which is supposed to guarantee an operationally reliable movement sequence. In the present exemplary embodiments, the recipient guide 19 interacts with the tension rods 13, and this guarantees relatively simple structural implementation. It is understood that in alternative embodiments, more complex guide mechanisms can also be provided, if applicable.

The extrusion residue shears 10 shown in the drawings have a shearing blade 20, in each instance, which is held by a shearing blade carrier 21. It is understood that in deviating embodiments, it is possible to do without a separate shearing blade carrier, if applicable, for example if overly great wear is not expected. Also, in particular in the case of such expectations, the shearing blade can be configured in one piece with the shearing blade carrier, if applicable.

Configuration of the shearing blade 20 separate from the shearing blade carrier 21, in contrast, makes easy replacement possible, in the case of suitable fastening of the shearing blade 20 to the shearing blade carrier 21, for example in case of wear.

The extrusion residue shears 10 furthermore have a shearing drive 30, in each instance, which can displace the shearing blade 20 and, if applicable, the shearing blade carrier 21, with reference to a frame 40 of the extrusion residue shears 10, in particular for a shear-off movement.

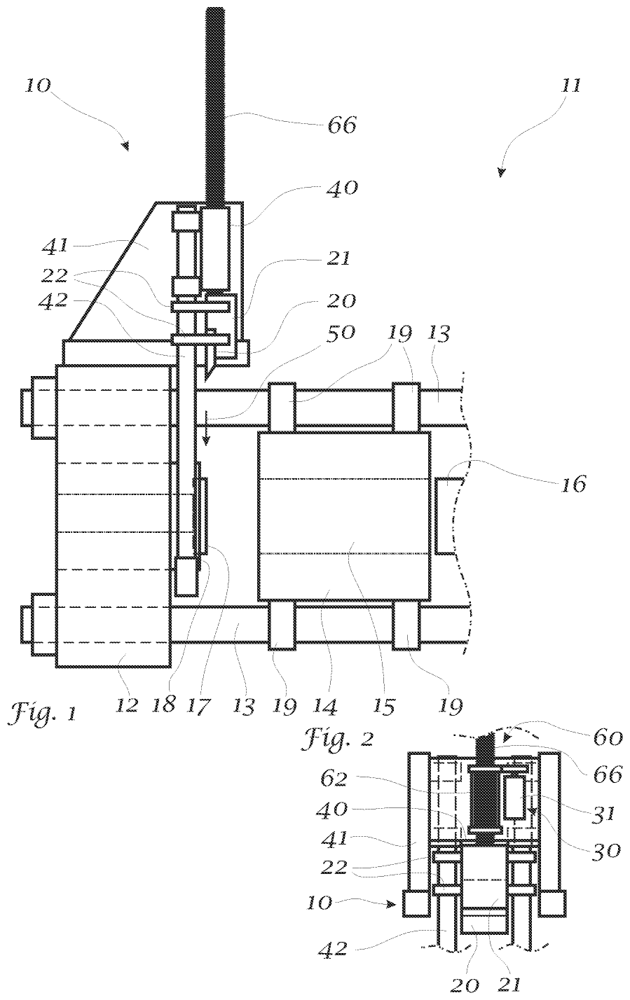

The frame, as shown as an example, for example in FIGS. 1 to 8, can be attached to the extrusion press 11 by way of a holder 41, in particular, for example, to the die yoke 12 (see FIGS. 1, 3, and 5). It is understood that if applicable, other modules, such as, for example, the recipient 14, a separate moving crossbeam, the die carrier 18, or even building floors can also be used accordingly in deviating embodiments. In this regard, the exemplary embodiments in which a holder 41 is not explicitly shown also have a corresponding holder, if this appears to be advantageous.

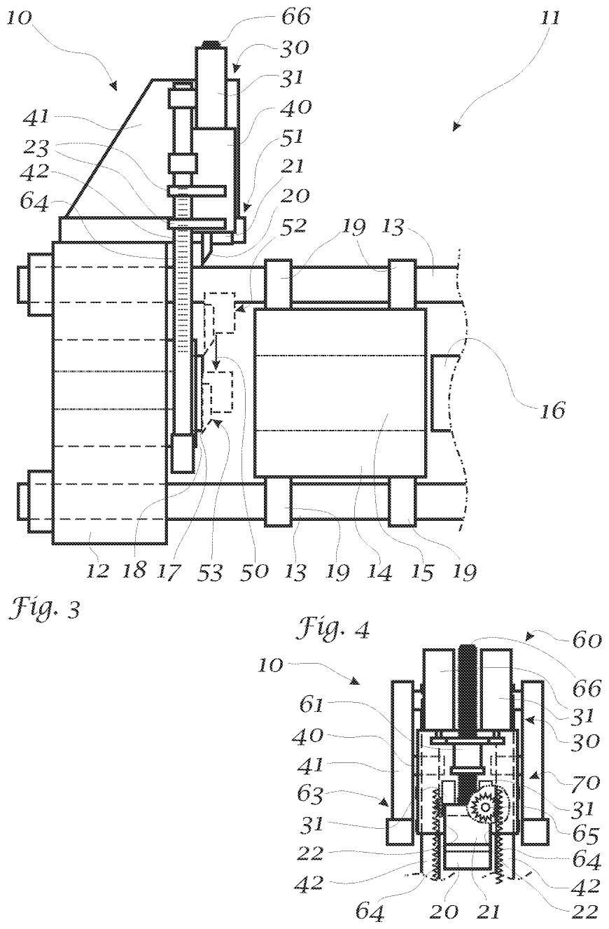

In all the exemplary embodiments, the shearing blade 20 can be moved, by means of the shearing drive 30, in a shear-off movement direction 50, from a shearing start position 52 to a shearing end position 53 (shown as an example only in FIG. 3). In this regard, the shearing start position 52 is selected in such a manner that starting from this position, a movement of the shearing blade 20 in the shear-off movement direction 50 leads to shearing off if a corresponding extrusion residue is found there, whereas when the shearing end position 53 is then reached, the shearing process has been ended in the desired manner.

In a concrete implementation, the shearing blade will reach the edge of the die 17 with its edge having the shearing effect, in the shearing start position 52, directed at the die, while in the shearing end position 53, the shearing blade 20 will generally be positioned facing away from the die 17, with its edge facing away from the edge of the die 17, as this is shown as an example in FIG. 3.

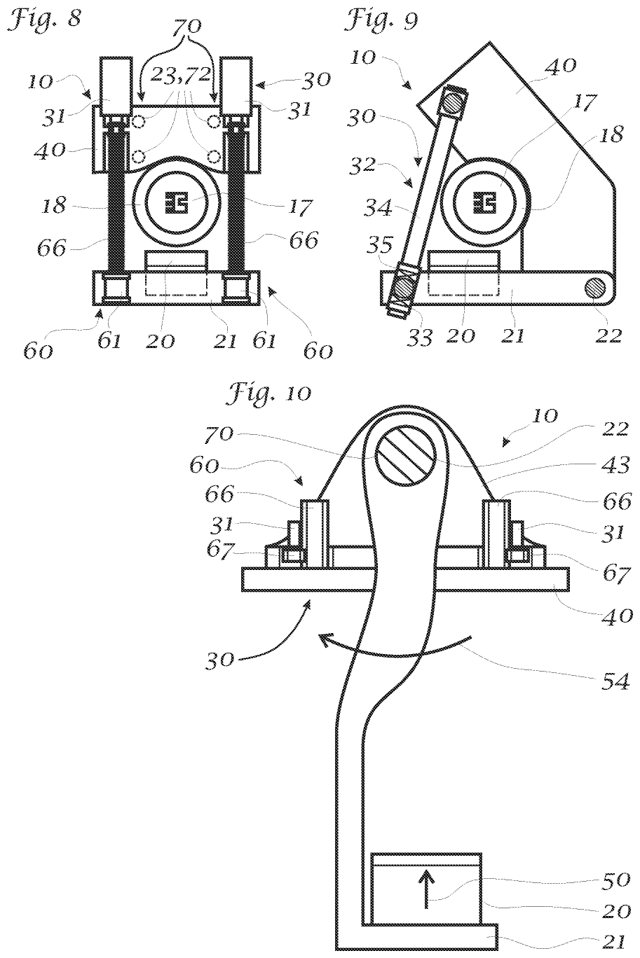

The corresponding shearing-off movement of the shearing blade 20 is implemented, in the exemplary embodiments, by means of a carrier guide 22, which is already brought about, in the exemplary embodiments according to FIGS. 8 and 10, essentially by means of the configuration of the shearing drive 30, so that in these figures, no separate numbering is provided.

Because the shearing blade 20 can generally be a hindrance during extrusion or also during other operating states of the extrusion press 11, a waiting position 51 is provided, in which the extrusion residue shears 10 are positioned in such a manner that they do not interfere. Depending on the concrete embodiment, the shearing blade 20 and, if applicable, further modules can be positioned from the shearing end position 53 or from the shearing start position 52 to the waiting position 51 by means of the shearing drive 30 or using a positioning drive 70, as this is shown in different ways, as an example, in the exemplary embodiments.

Thus, in the exemplary embodiment according to FIGS. 1 and 2, the shearing drive 30 as such can displace the shearing blade 20 by means of its carrier guide 22 and two guide rods 42 of the frames 40, which guide the carrier guides 22, in each instance, from a waiting position 51 (shown in FIG. 1) to the shearing start position or shearing end position not shown in FIG. 1, and back. In this regard, the guide rods 42 are also anchored on the die carrier 18, in a manner that is not explained in any detail but can easily be understood with regard to a concrete implementation possibility, so that the shearing forces can be absorbed as well as possible. In this regard, the concrete embodiment is selected in such a manner that the guide rods 42 in this embodiment do not hinder the movement sequences that the extrusion press 11 must perform, for the remainder. It is understood that in deviating embodiments other solution approaches can be provided here, as well.

In contrast, the exemplary embodiment shown in FIGS. 3 and 4 makes use of a separation between the positioning drive 70 and the shearing drive 30, wherein the positioning drive 70 is ultimately optimized for the fastest possible displacement, while the shearing drive 30 is optimized for the application of great forces.

For this purpose, the embodiment shown in FIGS. 3 and 4 makes use of a frame guide 23, by means of which a part of the frame 40 can be displaced along the guide rods 42, which are configured, in this exemplary embodiment, as gear racks 64.

In this exemplary embodiment, the shearing blade carrier 21 is guided by means of a carrier guide 22, which engages on the movable part of the frame 40 in comparison with the exemplary embodiment according to FIGS. 1 and 2, wherein this movable part also carries the shearing drive 30 and a related geared connection 60.

In the exemplary embodiments according to FIGS. 1 to 8, rotational electric motors 31 are used, in each instance, and can drive the shearing blade carrier 21 or the shearing blade 20, in particular for the shear-off movement but also, if applicable, beyond it, by way of suitable geared connections 60.

Thus, in the exemplary embodiment according to FIGS. 1 and 2, roller screws 62 are used as geared connections 60, in each instance, which lead to advancing of a spindle 66, so that the shearing blade 20 can be displaced in the manner described.

In the exemplary embodiments according to FIGS. 3 to 8, in contrast, ball screws 61 are used, which mesh with spindles 66 and allow displacement in this way. Thus, also in the exemplary embodiment according to FIGS. 3 and 4, the shearing blade 20 or the shearing blade carrier 21 is displaced in that by means of the ball screw 61, a spindle 66 is driven in accordance with the desired movement of the shearing blade 20. In this regard, in this exemplary embodiment two electric motors 31 serve for drive of the ball screw 61, so that, for example in distinction from the exemplary embodiment shown in FIGS. 1 and 2, electric motors 31 having low power can be used. It is understood that if applicable, a corresponding arrangement can also be used in the exemplary embodiment according to FIGS. 1 and 2.

In this exemplary embodiment, the drive train with which the positioning drive 70 can displace a part of the frame 40 from the waiting position 51, in the direction of the die 17 and back again, a rack and pinion gear 63, which comprises a gear rack 64 and a gear wheel 65, in each instance, can be driven accordingly by the positioning drive 70, which can also be configured as a rotational electric motor 31 in this exemplary embodiment.

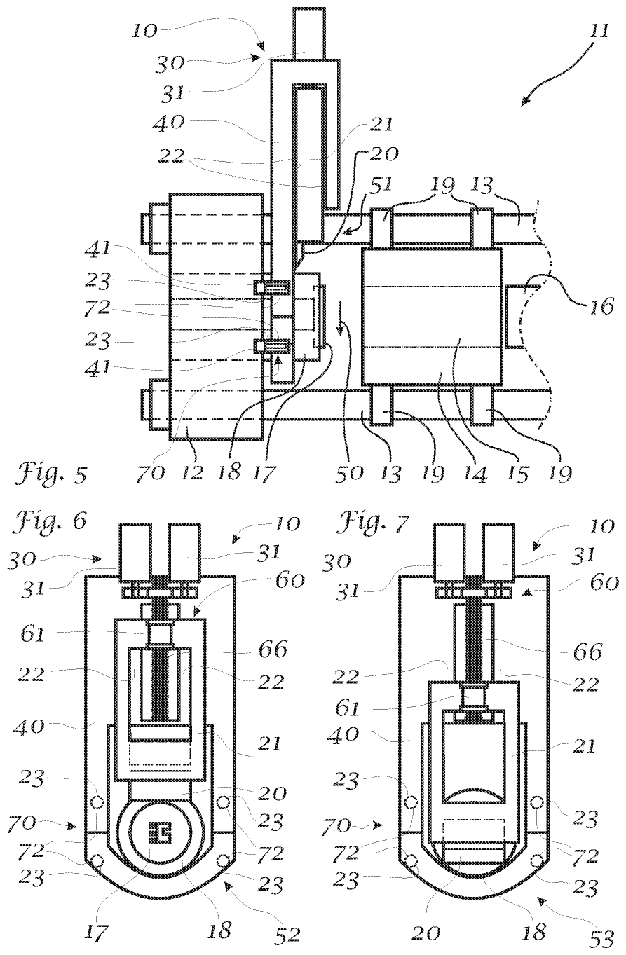

In the exemplary embodiment in FIGS. 5 to 7, the spindle 66 remains fixed in place and is driven by means of two rotational electric motors 31, while the ball screw 61 runs along the spindle 66 in a linear manner and brings about the desired movement of the shearing blade carrier 21 or of the shearing blade 20 or follows it. In this exemplary embodiment, as well, two rotational electric motors 31 are used, so that their power can be selected to be correspondingly low.

Furthermore, the positioning drive 70, in this exemplary embodiment, comprises four linear motors 72, in order to allow a positioning movement from the waiting position in the direction toward the recipient 14, between a small holder 41 that is arranged on the die yoke 12 and a frame 40 that is guided on the die carrier 18.

A corresponding positioning movement is also provided by the exemplary embodiment according to FIG. 8, wherein there the shearing drive 30 provides two spindles 66 that are driven to rotate, in each instance, along which the desired movement of the shearing blade 20 in or counter to the shear-off movement direction can be imposed by a ball screw 61, in each instance.

As is directly evident, in this embodiment the shearing blade 20 is pulled in the direction of the shear-off movement direction 50 by means of the shearing drive 30, and this allows a particularly compact construction and a precise shearing movement.

In the embodiment according to FIG. 9, as well, the shearing blade 20 is pulled along the shear-off movement direction 50, so that the same advantages occur, wherein in this figure, a positioning movement or a positioning drive is not shown, but this can be provided in accordance with the possibilities explained above.

In the exemplary embodiment shown in FIG. 9, the shearing drive 30 comprises a linear actuator 32, which is implemented by means of a linear motor 33 having a stator 34 and an actor 35 in this exemplary embodiment. It is understood that in deviating embodiments, stator 34 and actor 35 can also be exchanged, if applicable. Likewise, instead of the linear motor 33, other types of linear actuators can also be used accordingly.

The exemplary embodiment shown in FIG. 10 also uses a geared connection 60 so as to convert a rotational movement of a rotational electric motor 31 to a linear connection, wherein the corresponding geared connection 60 comprises, in each instance, a fixed spindle 66, along which a counter-spindle 67 connected with an electric motor 31, in each instance, runs, wherein in this exemplary embodiment no rolling screw thread has been provided, and the two spindles 66, 67 mesh with one another in conventional manner.

In this exemplary embodiment, the electric motors 31 and the counter-spindle 67 are arranged on a carrier unit 43, which follows the shear-off movement together with the shearing blade 20.

Furthermore, a positioning drive 70 is provided on the carrier unit 43, which drive can drive a shaft as a direct drive, which shaft in turn serves as a carrier guide 22 and, on the other hand, can move the shearing blade carrier 21 as well as the shearing blade 20 in a movement direction 54 to the waiting position. With a corresponding reversal of the movement direction 54, a return movement to the shearing start position 52 can then take place.

It is understood that the drive trains or shearing drives 30 or positioning drives 70 of the different exemplary embodiments, in each instance, can certainly be exchanged or modified in a suitable manner. In particular, it is understood that corresponding linear actuators 32, as they are shown in the exemplary embodiment according to FIG. 9, can also be used in the other exemplary embodiments as a shearing drive 30 and/or as a positioning drive 70. Vice versa, the drive technology shown in the other exemplary embodiments can also be used in the exemplary embodiment according to FIG. 9. The same also holds true for the different couplings between the electric motors 31 and the geared connection 60, as well as the different embodiments of the geared connections 60 as such, which can be exchanged, in each instance, in the exemplary embodiments, if applicable with suitable adaption.

In particular, it is not compulsory that rolling screw threads, in other words ball screws 61 or roller screws 62, in each instance, are used. In particular, conventional types of threads can also be used accordingly. Accordingly, the combinations selected in the exemplary embodiments, between shearing drive 30, positioning drive 70, shear-off movement direction 50, orientation of the shearing blade carrier 21 with reference to the shear-off movement direction 50, the precise embodiment of the positioning movement and the shearing movement and other items can easily be exchanged between the exemplary embodiments, in each instance.

Although only a few embodiments of the present invention have been shown and described, it is to be understood that many changes and modifications may be made thereunto without departing from the spirit and scope of the invention.

Reference Symbol List:

| | |
|---|---|
| 10 | extrusion residue shears |
| 11 | extrusion press |
| 12 | die yoke |
| 13 | tension rod |
| 14 | recipient |
| 15 | receiving space |
| 16 | punch |
| 17 | die |
| 18 | die carrier |
| 19 | recipient guide |
| 20 | shearing blade |
| 21 | shearing blade carrier |
| 22 | carrier guide |
| 23 | frame guide |
| 30 | shearing drive |
| 31 | rotational electric motor |
| 32 | linear actuator |
| 33 | linear motor |
| 34 | stator of the linear motor 33 |
| 35 | actor of the linear motor 33 |
| 40 | frame of the extrusion residue |
| | shears 10 |
| 41 | holder |
| 42 | guide rod |
| 43 | carrier unit |
| 50 | shear-off movement direction |
| 51 | waiting position |
| 52 | shearing start position |
| 53 | shearing end position |
| 54 | movement direction to the |
| | waiting position |
| 60 | geared connection |
| 61 | ball screw |
| 62 | roller screw |
| 63 | rack and pinion gear |
| 64 | gear rack |
| 65 | gear wheel |
| 66 | spindle |
| 67 | counter-spindle |
| 70 | positioning drive |
| 72 | linear motor |

What is claimed is:

1. An extrusion residue shears (10) for extrusion presses (11), having a shearing blade (20) and a shearing drive (30), which moves the shearing blade (20) correspondingly with reference to a frame (40) of the extrusion residue shears (10) during a shearing movement that runs along a shear-off movement direction (50), wherein the shearing drive (30)
(i) is connected with the shearing blade (20) by means of a geared connection (60) that acts with push; and/or
(ii) comprises a linear actuator (32) that performs the shearing movement; and/or
(iii) can be driven both with force regulation and with speed regulation; and/or
(iv) drives the shearing blade (20), for the shearing movement, along a shearing blade carrier (21), which extends in the shear-off movement direction (50), proceeding from the shearing blade (20), or together with a shearing blade carrier (21) that extends in the shear-off movement direction (50), proceeding from the shearing blade (20); and/or
(v) is switched in series with a separately configured positioning drive (70) for carrying out a positioning movement of the shearing blade (20), which movement has a directional component in common with the shearing movement, from a waiting position (51) to a shearing start position (52) and/or from a shearing end position (53) to the waiting position (51).

2. The extrusion residue shears (10) according to claim 1, wherein the geared connection (60) that also acts with push comprises a toothed gear mechanism or is configured as such a gear mechanism.

3. The extrusion residue shears (10) according to claim 1, wherein the geared connection (60) that also acts with push is a mechanical, in particular a shape-fit geared connection, which preferably comprises a nut/spindle gear mechanism for changing a rotational movement of the shearing drive (30) into the shearing movement.

4. The extrusion residue shears (10) according to claim 1, wherein the shearing drive (30), in particular, if applicable, the linear actuator (32), can also perform or performs a positioning movement of the shearing blade (20) from a waiting position (51) to a shearing start position (52) and/or from a shearing end position (53) to the waiting position (51) and/or that the shearing drive (30) is used both for drive of a shearing movement and for drive of a positioning movement.

5. The extrusion residue shears (10) according to claim 1, wherein the linear actuator (32) also carries out a positioning movement.

6. The extrusion residue shears (10) according to claim 1, wherein the shearing drive (30) comprises an electric motor or that the linear actuator (32) is configured as an electric motor.

7. The extrusion residue shears (10) according to claim 1, wherein the positioning drive (70) is configured as an electric motor.

8. The extrusion residue shears (10) according to claim 1, wherein the shearing movement and the positioning movement make a constant transition into one another, in particular with a constant change in direction change or even without a change in direction.

9. The extrusion residue shears (10) according to claim 1, wherein the shearing drive (30) for the shearing blade (20), which is carried by the shearing blade carrier (21) that extends in the shear-off movement direction (50), is connected to the shearing blade (20) by means of a geared connection (60), which comprises a gear mechanism element that acts only with pull.

10. The extrusion residue shears (10) according to claim 1, wherein the shearing drive (30) for the shearing movement is force-regulated and otherwise speed-regulated and/or that the shearing drive (30) comprises a force sensor and/or a torque sensor and/or that a force sensor or torque sensor is provided in the flow of force between the shearing drive (30) and the shearing blade (20).

11. A method for shearing off an extrusion residue in an extrusion press (11), by means of a shearing blade (20), wherein the shearing blade (20)
(i) is drawn against the extrusion residue in order to shear off the extrusion residue; and/or
(ii) is first brought from a waiting position (51) to a shearing start position (52), then displaced, for the shearing process, by means of a shearing movement, into a shearing end position (53), and subsequently brought back into the waiting position (51), wherein the shearing movement is driven by means of a shearing drive (30), and at least one of the other movements, having a directional component in common with the shearing movement, is driven by a positioning drive (70) that is separate from the shearing drive (30); and/or
(iii) is driven both with force regulation and with speed regulation.

12. The method according to claim 11, wherein drawing of the shearing blade (20) against the extrusion residue takes place from a side of the extrusion residue that faces away from the shearing blade (20).

13. The method according to claim 11, wherein shearing off or the shearing movement takes place by means of an electric motor.

14. The method according to claim 11, wherein the shearing drive (30) is force-regulated during the shearing movement and preferably speed-regulated for the remainder.
